(19) United States
(12) Patent Application Publication
(10) Pub. No.: US 2005/0276476 A1
(43) Pub. Date: Dec. 15, 2005

(54) Method of exposure compensation for simulating the dynamic range of human eyes

(75) Inventor: Tzu-Lung Lin, Taichung Shien (TW)

Correspondence Address: BRUCE H. TROXELL, 5205 LEESBURG PIKE, SUITE 1404, FALLS CHURCH, VA, 22041, US

(73) Assignee: AIPTEK International Inc.

(21) Appl. No.: 10/863,222

(22) Filed: Jun. 9, 2004

(51) Int. Cl. G06K 9/00; G06K 9/34

(52) U.S. Cl. 382/169; 382/167

(57) ABSTRACT

A method of exposure compensation for simulating the dynamic of human eye comprises the following steps: sampling the brightness of an image; plotting a brightness level graph; converting the brightness level graph into a histogram of brightness; converting the histogram of brightness into a percentile diagram of brightness; converting the percentile diagram of brightness into a diagram of gamut curve; and replacing the gamut curve of the original image with the new gamut curve to obtain a modified image. Thereby, color level of the large part of low brightness can be raised to show the details of the image, and an excellent image quality is available.

### FIELD OF THE INVENTION

The present invention relates to an exposure compensation method capable of simulating the dynamic range of human eyes, and more particularly, to an exposure compensation method adapted for the images captured by an electronic digital imaging device.

### BACKGROUND OF THE INVENTION

Digital imaging systems are becoming increasingly popular. Especially the digital camera and the digital camcorder are the most prevalent goods among the products of the digital imaging industry. The reasons why the digital imaging products is well-liked by consumers are as following:

(1) Convenience: Most current digital imaging products have a built-in LCD monitor capable of display an image captured by the same in real time such that the quality of the captured imaged is realized immediately and conveniently without the trouble of having to develop films by a professional technician as a conventional camera.

(2) Cost-saving capability: The costs for viewing an image captured by a conventional camera includes: price of film, cost for developing the film, and cost for print the photography, which might amount to a small fortune. On the other hand, the digital camera stores images in the built-in memory or memory card capable of transferring the captured images to a storage media of personal computer for viewing with almost no cost.

(3) Potential for improving photographic technique: Since the cost of taking pictures with a digital camera is very low, that is, it will cost only to recharge the battery of the digital camera and to purchase sufficient memory card for storing images, the photographer using a digital camera can practice on changing the settings, such as shutter speed, diaphragm, white balance and exposure compensation, etc., for seeking the best shooting parameters for the intended image without worrying the consequent expense, such that the photographer is able to gain precise photo experience and thus improve his photographic technique.

(4) Post-production ability: Do you ever get your film developed and realize that only half of the pictures turned out correctly and can not be remedied? With a digital camera, the photographer can view the picture immediately after its taken and perform some editorial post-production works on the captured image using some image processing software for bettering the photo to a real image or adding special effects to the photo.

Due to the aforementioned advantages, it is easy to understand the recent booming expansion of patent applications for the digital imaging products and the corresponding application software.

The human eyes see detail in both dark and light areas of a scene however a camera may not be able to do so. This occurs particularly when a scene consists of large very bright and dark or high contrast areas. As shown in FIG. 1, the object to be captured is a ceiling consisted of a large dark area 1 and a small highly bright area 2 at the left corner shined by a fluorescent light. The digital imaging device detects the light emitted from the fluorescent light and will mistakenly judge the whole area of the ceiling to be captured to be well illuminated that the digital imaging device will stop the flash light from functioning and reduce the overall exposure value (EV), which is measured in “step”. Thus, the resulting digital image may have a low brightness for human eye so that the details of dark area of the ceiling will be invisible. Such image is unacceptable.

If the problem above is solved by adjusting the built-in exposure compensation system of the digital imaging device, the exposure value of the whole captured image can be raised by one step. This results in the over-exposed fluorescent light in the image, and the color level of the large area 1 is not obvious and noises caused by insufficient light are formed. The invention can modify the large area via a transfer graph to present the color level and details of the large area and narrow the color level of the small area, thereby obtaining a brightness-balanced image.

### SUMMARY OF THE INVENTION

It is a primary object of the present invention to provide an exposure compensation method for simulating the dynamic range of human eyes. The method of the present invent uses a process of color level adjustment to sample the captured image according to the overall gamut thereof and plot the sampling result into a chart, and then adjusting the histogram of the chart so as to raise the color level of a large dark area for revealing the details thereof.

Another object of the invention is to provide an image processing method to simulate the function of human eye.

The third object of the invention is to adjust the color level of the large area of the image to enrich the color level and details of the image, and simultaneously narrow the color level of the small area which is over-exposed so as to obtain a balanced image.

To achieve the aforementioned objects, the exposure compensation method for simulating the dynamic range of human eye of the present invention comprises the following steps:
sampling the brightness of an image;
plotting a brightness level graph;
converting the brightness level graph into a histogram of brightness;
converting the histogram of brightness into a color level diagram; and
replacing the original color level diagram with the new color level diagram to obtain a modified image.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a image caught by a conventional electronic digital imaging device.

FIG. 2 is a histogram plotted by sampling the image caught by the electronic digital imaging device.

FIG. 3 is a percentile diagram of FIG. 2.

FIG. 4 is a color level diagram transformed from the percentile diagram of FIG. 3.

FIG. 5 is an original color level diagram;

FIG. 6 is a flowchart of the exposure compensation method for simulating dynamic range of human eye according to the present invention.

FIG. 7 is an image modified according to the color level diagram of FIG. 4.

### DESCRIPTION OF THE PREFERRED EMBODIMENT

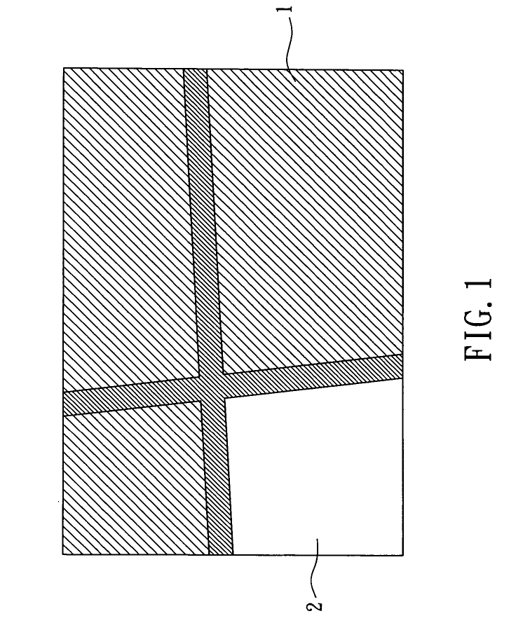

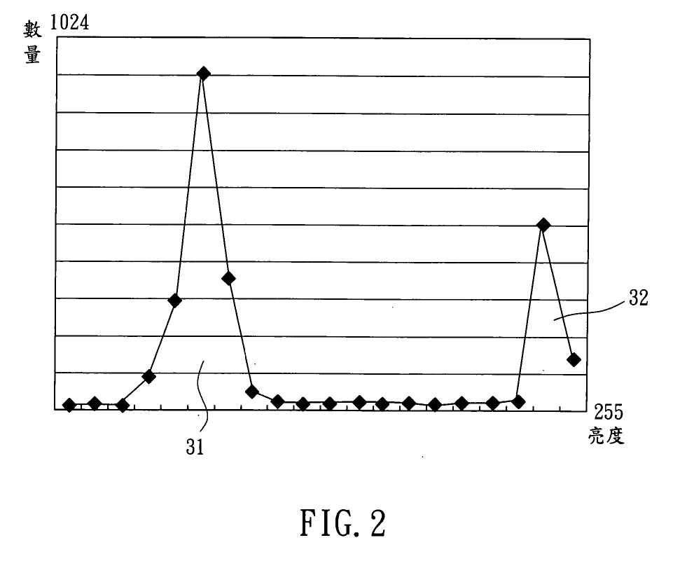

Please refer to FIG. 2, which is a histogram plotted by sampling the image caught by the electronic digital imaging device. The image for sampling is shown in FIG. 1, which includes a large dark area and a small bright area. The vertical coordinate represents the number of sampled pixels (e.g. 0-1023), and the horizontal coordinate represents the brightness of the sampled pixel (e.g. 0-255). The result of sampling is shown in a curve on which a plurality of small squares is positioned for calculation purpose. Between the third and the ninth small squares from the left, a first area 31 with a largest height is formed. The area 31 represents the brightness distribution of most image pixels sampled from the large dark area. Between the eighteenth and the twentieth small squares, a second area 32 with a height lower than the first area 31 is formed. The area 32 represents the distribution of brightness of the image pixels sampled from the small bright area, and the small bright area has an extremely high brightness.

The image mentioned above is unacceptable, because the color level and details of the large area is non-obvious and the small area is over-emphasized. This is contrary to what we usually see, that is, human eyes will automatically focus on the large area and neglect the small area. The captured image is so different from the scene seen by human eyes that a clever method is needed for modifications.

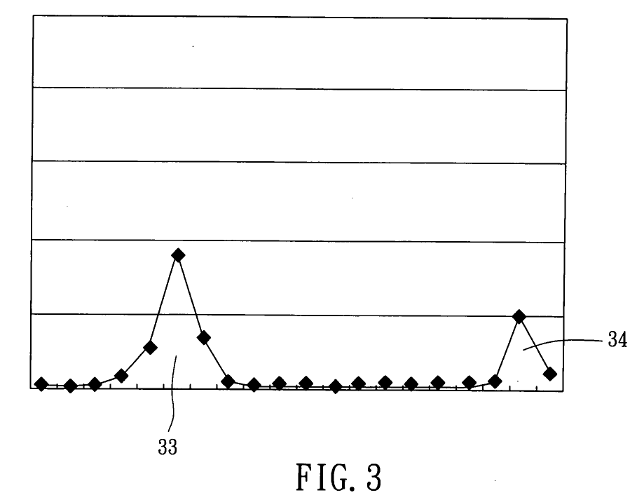

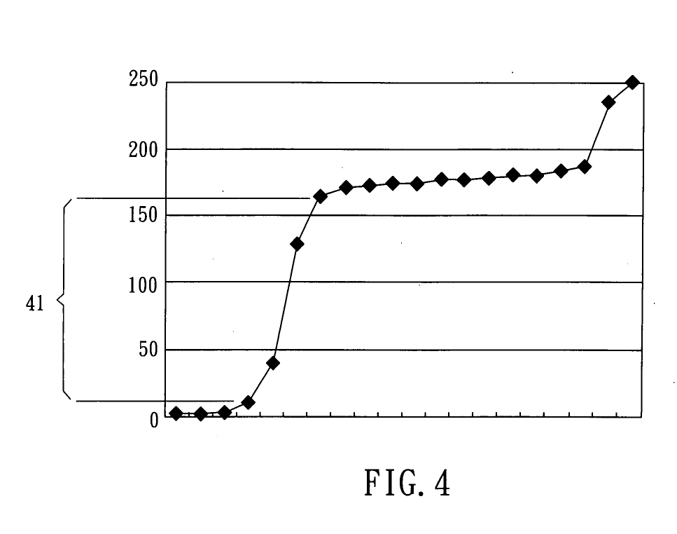

Please refer to FIG. 3, which is a percentile diagram of FIG. 2. FIG. 3 is transformed from FIG. 2 according to the sampled pixels of certain brightness values over all sampled pixels. The brightness percentile diagram provides cumulative values for calculation of the color level diagram shown in FIG. 4.

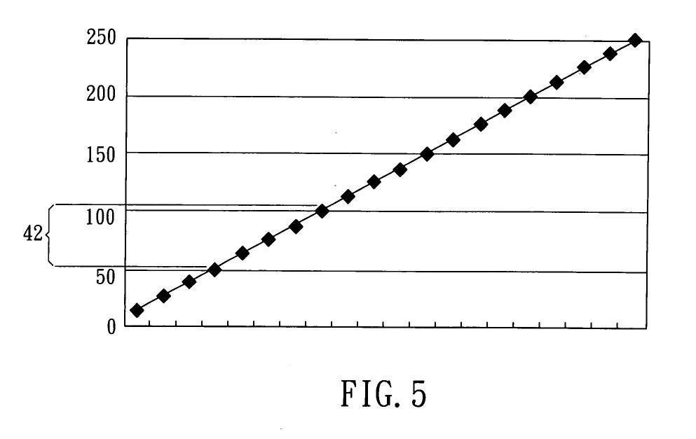

FIG. 4 is a color level diagram calculated from the percentile diagram of FIG. 3. The curve in FIG. 4 is plotted according to a cumulative value of Gamma values. For example, the value of the first small square in FIG. 4 is the origin value added by the first small square value in FIG. 3. The value of the second small square in FIG. 4 is the first small square value added by the second small square value in FIG. 3, and the value of the third small square in FIG. 4 is the second small square value added by the third small square value in FIG. 3, and so on. When one small square value in FIG. 3 is not zero, the corresponding small square value will be rapidly increased to form a sharp curve (shown between the fourth small square to the seventh small square in FIG. 4). The sharp curve is used to adjust a Gamma curve with fixed slope (as shown in FIG. 5). It means that the large dark area is substantially modified in brightness (rapidly increase in the cumulative small square value) and the color level of the area becomes obvious. A horizontal line is formed from the eighth small square to the eighteenth small square due to no cumulative value existed in-between. Although certain values are cumulated between the eighteenth small square and the twentieth small square, the fluorescent light has a smaller area and the curve slope therebetween is smaller than the curve slope between the fourth small square and the seventh small square. The compression effect shown in the image corresponding to this section of the curve is remarkable.

The modified color level 41 between the fourth small square and the seventh small square in FIG. 4 (large area) has a color level ratio of 150/250. Compared with the original color level 42 between the fourth small square and the seventh small square in FIG. 5 (color level ratio is 50/250), the color level of the large area has as three times higher than ever, and the brightness is also higher. This approaches what is seen from human eyes.

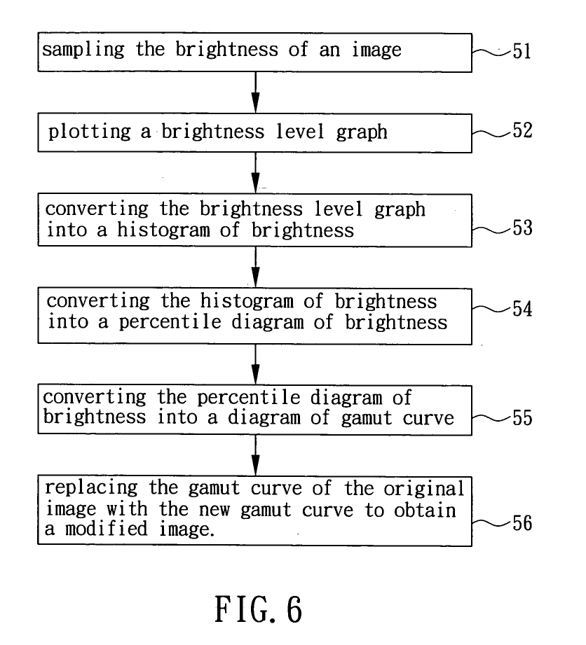

Referring to FIG. 6, the method of the invention is described as follows:
Step 51: Sampling the brightness of an original image;
Step 52: Calculating the number of pixels corresponding to each brightness value (0-255);
Step 53: Calculating the percentage of each brightness value and plotting a percentile diagram according the calculated percentage;
Step 54: Cumulating the pixel number of each brightness value and plotting a histogram according to the cumulated value; and
Step 55: Replacing the original Gamma color level curve with the Gamma color level curve of FIG. 4 to obtain a modified image.

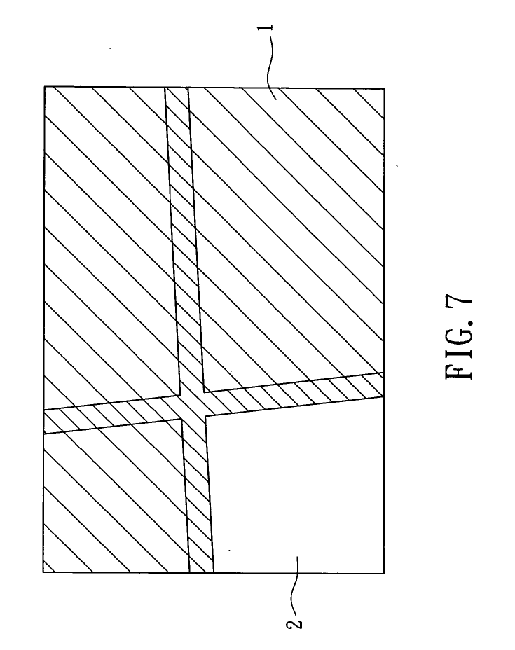

Referring to FIG. 7, the image modified by the new Gamma curve has an improved brightness and clear details in the large area as well as a narrowing effect on the color level of the small area.

To sum up, from the structural characteristics and detailed disclosure of each embodiment according to the invention, it sufficiently shows that the invention has progressiveness of deep implementation in both objective and function, also has the application value in industry, and it is an application never seen ever in current market and, according to the spirit of patent law, the invention is completely fulfilled the essential requirement of new typed patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A method of exposure compensation for simulating the dynamic range of human eye, comprising the steps of:
sampling the brightness of an image;
plotting a brightness level graph;
converting the brightness level graph into a histogram of brightness;
converting the histogram of brightness into a color level diagram; and
replacing the original color level diagram of the image with the color level diagram to obtain a modified image.

2. The method of exposure compensation for simulating the dynamic range of human eye as claimed in claim 1, wherein the color level diagram is formed by calculating and accumulating a gamma value.

3. The method of exposure compensation for simulating the dynamic range of human eye as claimed in claim 1, the method further comprising a step of:
converting the histogram of brightness into a percentile diagram of brightness to be converted into a color level diagram before converting the histogram of brightness into the color level diagram.

4. The method of exposure compensation for simulating the dynamic range of human eye as claimed in claim 1, wherein the vertical coordinate of the histogram represents the amount of sampled pixels of the image according to a certain brightness, and the horizontal coordinate represents the brightness of the image.

5. The method of exposure compensation for simulating the dynamic range of human eye as claimed in claim 1, wherein the method can be applied to a device selected from the group consisting of either a digital camcorder and a digital camera.
